(19) United States
(12) Patent Application Publication
(10) Pub. No.: US 2015/0348370 A1
(43) Pub. Date: Dec. 3, 2015

(54) Computer-implemented lottery ticket pooling system

(71) Applicants: Edward M. Lijoodi, Eden Prairie, MN (US); Kaisa Kivilaid, Eden Prairie, MN (US)

(72) Inventors: Edward M. Lijoodi, Eden Prairie, MN (US); Kaisa Kivilaid, Eden Prairie, MN (US)

(73) Assignee: EDWARDIAN PUBLISHING, LLC, Minneapolis, MN (US)

(21) Appl. No.: 14/293,910

(22) Filed: Jun. 2, 2014

(51) Int. Cl. G07F 17/32

(52) U.S. Cl. CPC G07F 17/3274; G07F 17/329

(57) ABSTRACT

A computer-implemented process that allows lottery players to consolidate their tickets into a pool with other lottery players, so that winnings from any ticket in the pool will be equally distributed between all the players/tickets in the pool. The process can be applied to any US national or international lottery (non-scratch game) where a certain set of number is selected from a certain group of numbers. The pool sizes must be pre-determined for each applicable lottery to confirm that any possible set of winning tickets can be equally divided between all the players or tickets in the pool. The process can be executed by any suitable computer software.

### TECHNICAL FIELD

The present invention relates to non-scratch lottery gaming systems, methods and software products, and performs automated pooling of lottery tickets.

### SUMMARY OF THE INVENTION

### Technical Problem

There are no current national or international lottery gaming systems that allow players to consolidate their tickets. Lottery players who wish to be part of a pool need to find people among their acquaintances. This invention allows lottery players to pool their tickets based on either a randomly selected pool size, or a pool size of the player's choosing.

### Solution to Problem

The present invention is computer-implemented method that allows users to combine their lottery tickets into a ‘pool’ while keeping the price of the ticket the same, but increasing the potential for a payout. This pooling process can be applied to any US national or international non-instant (i.e., scratch ticket) lottery, such as Powerball (choose five numbers from 1 to 59, sixth from 1 to 35) or Mega Millions (choose five numbers from 1 to 75, sixth from 1 to 15).

### Advantageous Effects of Invention

This invention is intended to allow lottery players to pool their tickets so that the winnings are equally distributed between all the players/tickets in the pool, increasing the odds of a player receiving a payout. The same process can be applied to any non-instant (i.e., scratch games) lottery game, such as Powerball or Mega Millions.

The pooling is performed by computer software. When a player wishes to “pool” their lottery ticket, the size of the pool is either chosen randomly by the computer software or by the player. The computer also assigns the ticket/player to a randomly chosen pool (based on the chosen pool size). The pooling does not affect the price of the ticket, however, it does allow the player to receive a payout even if their ticket did not turn out to be a winning ticket.

The pool sizes must be pre-determined so that all possible payout amounts can be equally distributed between all the players/tickets in the pool. This involves finding all common divisors. For example, since Powerball lottery has possible prizes of $4, $7, $100, $10000 and $1000000 (without the jackpot), the possible pool sizes are 2, 4, 5, 10, 20, 25, 50 and 100. Similarly, for Mega Millions, the possible pool sizes are 2, 4, 5, 10, 20, 25 and 50. The same process must be applied to all other applicable lottery games to determine possible pool sizes.

### BRIEF DESCRIPTION OF DRAWING

FIG. 1 is included to provide a further understanding of the invention and is incorporated in and constitutes a part of this specification, illustrates embodiments of the invention and together with the description serves to explain the principles of the invention:

Component A is a diagram representing a lottery player who wishes to consolidate their lottery ticket into a pool in the embodiment of the present invention;

Component B is a diagram depicting a computing device for practicing an embodiment of the present invention;

Component C is a diagram demonstrating a choice of pool size (either random or picked by the player) by a computing device (component B) in the embodiment of the present invention;

Component D is a diagram showing a random choice of pool by a computing device (component B) in the embodiment of the present invention;

Component E is a diagram illustrating implementation of application of winnings to lottery tickets in the embodiment of the present invention;

Component F is a diagram summarizing total winnings by a player in the embodiment of the present invention.

### BRIEF DESCRIPTION OF PROGRAM

Program 1 presents detailed steps for the pooling process, including required inputs and outputs. Section I prepares the dataset to hold all the pools. Section II contains the macro, referred to as ‘play the lottery’, that fills the dataset presented in Section I with pooled tickets. Section III includes the macro calls to compile the dataset of all pooled tickets. Section IV presents the macro to assign a payout to each ticket (in reality, this is based on the lottery drawing), and consequently determine pool winnings and ticket/player payout. Section V includes the macro calls to process payouts per ticket.

Although this illustrative example is provided using SAS software, the pooling process under this invention can be modified and performed by any software program, such as R, C++ or SAS.

### DETAILED DESCRIPTION OF INVENTION

In the following description, numerous specific details are set forth in order to provide a thorough understanding of the present invention. Additionally, any examples set forth in these specifications are not intended to be limiting and merely set forth some of many possible embodiments for the claimed invention.

The invention discloses a system and method for lottery players to consolidate their non-scratch lottery tickets into a pool. The invention is intended to allow lottery players to consolidate their tickets by utilizing the invention's automated software pooling system. This process does not change the price of the tickets purchased by players, but does increase the odds of a player receiving any payout since the player would receive a payout if any of the tickets in the player's pool were a winner. At the time or purchase, the player will be given a ticket with their lottery picks and a unique pool identifier. The winnings are equally distributed between all the players/tickets in the pool.

This process can be used as a separate entity or accompany the software and/or hardware that are used by national and international lotteries when purchasing lottery tickets. A player can express their wish to enter their ticket in a pool when they purchase the ticket(s). The present invention would then randomly assign the player's ticket to a pool, where the pool size can be chosen at random or by the player. At a pre-determined time point prior to the lottery drawing, the pools will be closed (i.e., no more ‘pooling’ is allowed) to accommodate combining any open pools—pools where not all open slots have been filled.

This invention is proposed to be accompanied by a website where the player can check all the lottery picks for all the tickets in their pool. Given that at the time of ticket purchase the player's pool may not be complete, they can subsequently review all the picks on the website after entering their pool identifier that has been printed on their ticket.

The software that provides the pooling algorithm will keep track of all the pool identifiers (unique to each pool) and ticket identifiers (unique to each lottery ticket in a pool), so that the winning tickets can be easily identified. After the drawing, the software will determine whether each of the tickets that had been pooled were a winner or not, and what the winning amount was (an applicable payout amount of greater than 0 will be assigned to any ‘winning’ ticket, and a payout amount of 0 will be assigned to non-winners). All the payout amounts within each pool will be summed, providing a pool payout amount. The pool payout amount, given it will be greater than 0, will then be equally divided between the players/ticket holds in the specific pool to determine player/ticket payout.

It should be noted that since each applicable US national and international lottery is likely to have different prizes and payout amounts, the software will need to determine all common divisors so that each possible combination and winnings can be equally divided by all possible pool sizes, without the remainder. As such, the pooling process cannot be applied to tickets with unknown payout amounts (e.g., jackpot in Powerball drawing).

### Detailed Description of the Figure and Program

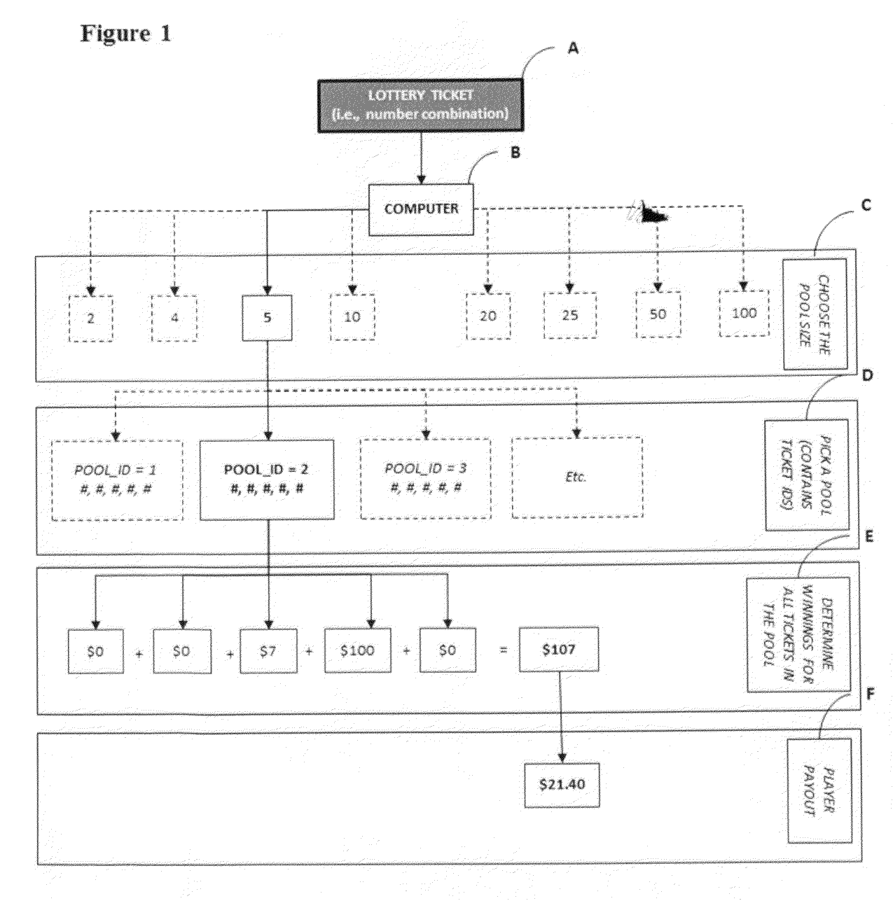

FIG. 1 illustrates the process of pooling the lottery tickets by providing an example:
Lottery ticket—a lottery player indicates that they want to be part of a pool.
Computer—a computer software is used to process the lottery ticket and enter it into a pool.
Choose the pool size—the computer software chooses the pool size from all the available pool sizes, either randomly or as directed by the player. In this example, the computer software chose a pool size of 5, among all possible pool sizes (here, 2, 4, 5, 10, 20, 25, 50 and 100).
Pick a pool—the computer software randomly chooses a pool from all the available pools of a given size, based on unique pool ID. In this example, the computer software chose pool ID of two. Since this is a pool of size five, it holds 5 lottery tickets.
Determine winnings—after the drawing, the computer software determines whether each ticket was a winning ticket (e.g., what is the payout associated with the ticket). More than one ticket in a pool can be a winner. In this example, one of the five tickets in the pool won $100, another ticket in the pool won $7, and the remaining three tickets won $0. Therefore, the entire pool payout was $107.
Player payout—determine the amount paid out to each player in this pool. This is equal to the total pool winnings divided by the pool size (i.e., number of players/tickets in the pool). In this example, the entire pool winnings were $107, therefore, each of the tickets/players will receive $21.40.

Program 1 presents detailed steps for the pooling process, including required inputs and outputs. This pooling process can be modified and performed by any computers software program, such as R, C++ or SAS.

| | |
|---|---|
| 1 | |
| 2 | options mprint; |
| 3 | |
| 4 | |
| 5 | **********************************************************************; |
| 6 | ***** SECTION I - set up the dataset of all pools *****; |
| 7 | **********************************************************************; |
| 8 | /* for illustrative purposes, make 3 pools of each possible size */ |
| 9 | data POOLS; |
| 10 | do POOL_ID = 1 to 3; POOL_SIZE = 2; output; end; |
| 11 | do POOL_ID = 4 to 6; POOL_SIZE = 4; output; end; |
| 12 | do POOL_ID = 7 to 9; POOL_SIZE = 5; output; end; |
| 13 | do POOL_ID = 10 to 12; POOL_SIZE = 10; output; end; |
| 14 | do POOL_ID = 13 to 15; POOL_SIZE = 20; output; end; |
| 15 | do POOL_ID = 16 to 18; POOL_SIZE = 25; output; end; |
| 16 | do POOL_ID = 19 to 21; POOL_SIZE = 50; output; end; |
| 17 | run; |
| 18 | |
| 19 | data POOLS2; |
| 20 | set POOLS; |
| 21 | by POOL_ID; |
| 22 | CLAIMED = .; |
| 23 | TICKET_ID = .; |
| 24 | PAYOUT_TICKET = .; |
| 25 | PAYOUT_PERSON = .; |
| 26 | WINNER = .; |
| 27 | PAYOUT_TICKET_FINAL = .; |
| 28 | PAYOUT_PERSON_FINAL = .; |
| 29 | POOL_REC = 1; output; POOL_REC = 2; output; POOL_REC = 3; output; |
| 30 | POOL_REC = 4; output; POOL_REC = 5; output; |
| 31 | POOL_REC = 6; output; POOL_REC = 7; output; POOL_REC = 8; output; |
| 32 | POOL_REC = 9; output; POOL_REC = 10; output; |
| 33 | POOL_REC = 11; output; POOL_REC = 12; output; POOL_REC = 13; |
| 34 | output; POOL_REC = 14; output; POOL_REC = 15; output; |
| 35 | POOL_REC = 16; output; POOL_REC = 17; output; POOL_REC = 18; |
| 36 | output; POOL_REC = 19; output; POOL_REC = 20; output; |
| 37 | POOL_REC = 21; output; POOL_REC = 22; output; POOL_REC = 23; |
| 38 | output; POOL_REC = 24; output; POOL_REC = 25; output; |
| 39 | POOL_REC = 26; output; POOL_REC = 27; output; POOL_REC = 28; |
| 40 | output; POOL_REC = 29; output; POOL_REC = 30; output; |
| 41 | POOL_REC = 31; output; POOL_REC = 32; output; POOL_REC = 33; |
| 42 | output; POOL_REC = 34; output; POOL_REC = 35; output; |
| 43 | POOL_REC = 36; output; POOL_REC = 37; output; POOL_REC = 38; |
| 44 | output; POOL_REC = 39; output; POOL_REC = 40; output; |
| 45 | POOL_REC = 41; output; POOL_REC = 42; output; POOL_REC = 43; |
| 46 | output; POOL_REC = 44; output; POOL_REC = 45; output; |
| 47 | POOL_REC = 46; output; POOL_REC = 47; output; POOL_REC = 48; |
| 48 | output; POOL_REC = 49; output; POOL_REC = 50; output; |
| 49 | run; |
| 50 | |
| 51 | data POOLS_FINAL; |
| 52 | set POOLS2; |
| 53 | if POOL_REC gt POOL_SIZE then delete; |
| 54 | run; |
| 55 | |
| 56 | |
| 57 | |
| 58 | **********************************************************************; |
| 59 | ***** SECTION II - choose a pool size, assign a lottery *****; |
| 60 | **********************************************************************; |
| 61 | %MACRO PLAY_LOTTERY(size=); |
| 62 | * (1) choose a pool size, (2) only keep the pools that have are not |
| 63 | fully claimed; |
| 64 | data _5pool; |
| 65 | set pools_final (where=(pool_size = &size and pool_size = |
| 66 | pool_rec and claimed = .)); |
| 67 | id = _N_; |
| 68 | run; |
| 69 | |
| 70 | * (2) now randomly choose one of the ‘open’ pools; |
| 71 | * determine the number of eligible tickets; |
| 72 | proc sql noprint; |
| 73 | select n(pool_id) into :nobs |
| 74 | from _5pool; |
| 75 | quit; |
| 76 | |
| 77 | * randomize the pools; |
| 78 | proc plan; |
| 79 | factors id = &nobs / noprint; |
| 80 | output out=_5pool2 data=_5pool; |
| 81 | quit; |
| 82 | |
| 83 | * pick only one pool, add a unique ticket id column; |
| 84 | data _5pool3; |
| 85 | set _5pool2; |
| 86 | if id=1; |
| 87 | ticket_id = ceil((99999999)*rand(“Uniform”)); |
| 88 | keep pool_id ticket_id; |
| 89 | format ticket_id z10.; |
| 90 | run; |
| 91 | |
| 92 | * (3) find the chosen ‘pool’ from the list of all pools; |
| 93 | data _null_; |
| 94 | set _5pool3; |
| 95 | call symput(‘poolid’, pool_id); |
| 96 | call symput(‘tickid’, ticket_id); |
| 97 | run; |
| 98 | |
| 99 | * (4) determine which pool record should be updated, finalize the ‘all |
| 100 | pools’ dataset; |
| 101 | data pools4; |
| 102 | set pools_final (where=(pool_id = &poolid and claimed ne 1)); |
| 103 | by pool_id pool_rec; |
| 104 | retain firstmiss; |
| 105 | |
| 106 | if first.pool_id then firstmiss = 0; |
| 107 | firstmiss = firstmiss + 1; |
| 108 | |
| 109 | if firstmiss = 1 then output; |
| 110 | keep pool_id pool_rec; |
| 111 | run; |
| 112 | |
| 113 | data _null_; |
| 114 | set pools4; |
| 115 | call symput(‘poolrec’, pool_rec); |
| 116 | run; |
| 117 | |
| 118 | * (5) update the ‘all pools’ dataset with the last claimed ticket; |
| 119 | proc sql; |
| 120 | update pools_final |
| 121 | set ticket_id = &tickid |
| 122 | where pool_id = &poolid and pool_rec = &poolrec; |
| 123 | |
| 124 | update pools_final |
| 125 | set claimed = 1 |
| 126 | where pool_id = &poolid and pool_rec = &poolrec; |
| 127 | quit; |
| 128 | %MEND play_lottery; |
| 129 | **********************************************************************; |
| 130 | ***** This section will be processed once per every play/ticket entr; |
| 131 | **********************************************************************; |
| 132 | |
| 133 | |
| 134 | |
| 135 | **********************************************************************; |
| 136 | ***** SECTION III - call the macro to fill the pools dataset *****; |
| 137 | **********************************************************************; |
| 138 | %MACRO PLAY_ALL; |
| 139 | %do i=1 %to 6; |
| 140 | %PLAY_LOTTERY(size=2); |
| 141 | %end; |
| 142 | %do i=1 %to 12; |
| 143 | %PLAY_LOTTERY(size=4); |
| 144 | %end; |
| 145 | %do i=1 %to 15; |
| 146 | %PLAY_LOTTERY(size=5); |
| 147 | %end; |
| 148 | %do i=1 %to 30; |
| 149 | %PLAY_LOTTERY(size=10); |
| 150 | %end; |
| 151 | %do i=1 %to 60; |
| 152 | %PLAY_LOTTERY(size=20); |
| 153 | %end; |
| 154 | %do i=1 %to 75; |
| 155 | %PLAY_LOTTERY(size=25); |
| 156 | %end; |
| 157 | %do i=1 %to 150; |
| 158 | %PLAY_LOTTERY(size=50); |
| 159 | %end; |
| 160 | %MEND PLAY_ALL; |
| 161 | |
| 162 | |
| 163 | %PLAY_ALL; |
| 164 | |
| 165 | |
| 166 | |
| 167 | **********************************************************************; |
| 168 | ***** SECTION IV - after the lottery drawing, determine which ticket |
| 169 | is a winner, output winnings *****; |
| 170 | **********************************************************************; |
| 171 | * (1) set a unique ticket id; |
| 172 | %MACRO winner(amount=); |
| 173 | data pools_final2; |
| 174 | set pools_final (where =(winner = .)); |
| 175 | id = _N_; |
| 176 | run; |
| 177 | |
| 178 | * (2) determine the number of eligible tickets; |
| 179 | proc sql noprint; |
| 180 | select n(id) into :nobs |
| 181 | from pools_final2; |
| 182 | quit; |
| 183 | |
| 184 | * (3) randomize the tickets, pick only 1 winner; |
| 185 | proc plan; |
| 186 | factors id = &nobs / noprint; |
| 187 | output out=pools_final3 data=pools_final2; |
| 188 | quit; |
| 189 | |
| 190 | * (4) determine winning amount, calculate payout by ticket and player; |
| 191 | data winner; |
| 192 | set pools_final3; |
| 193 | if id=1; |
| 194 | payout_ticket = &amount; |
| 195 | payout_person = payout_ticket / pool_size; |
| 196 | run; |
| 197 | |
| 198 | * (5) update the ‘all pools’ dataset with the winning ticket and the |
| 199 | payout amount; |
| 200 | data _null_; |
| 201 | set winner; |
| 202 | call symput(‘paytic’, payout_ticket); |
| 203 | call symput(‘payplay’, payout_person); |
| 204 | call symput(‘poolid’, pool_id); |
| 205 | call symput(‘ticketid’, ticket_id); |
| 206 | run; |
| 207 | |
| 208 | proc sql; |
| 209 | update pools_final |
| 210 | set payout_person = &payplay |
| 211 | where pool_id = &poolid; |
| 212 | |
| 213 | update pools_final |
| 214 | set winner = 1 |
| 215 | where ticket_id = &ticketid; |
| 216 | |
| 217 | update pools_final |
| 218 | set payout_ticket = &paytic |
| 219 | where ticket_id = &ticketid; |
| 220 | quit; |
| 221 | |
| 222 | * move winning amounts to final variables; |
| 223 | data pools_final; |
| 224 | set pools_final; |
| 225 | payout_person_final = sum(payout_person_final, payout_person); |
| 226 | if payout_ticket_final = . then payout_ticket_final = |
| 227 | payout_ticket; |
| 228 | format payout_person payout_person_final dollar16.2 |
| 229 | payout_ticket_final payout_ticket dollar18.; |
| 230 | run; |
| 231 | |
| 232 | data pools_final; |
| 233 | set pools_final; |
| 234 | payout_ticket = .; |
| 235 | payout_person = .; |
| 236 | run; |
| 237 | |
| 238 | %MEND winner; |
| 239 | **********************************************************************; |
| 240 | ***** This section will be processed once per every winning ticket; |
| 241 | **********************************************************************; |
| 242 | |
| 243 | |
| 244 | **********************************************************************; |
| 245 | ***** SECTION V - call the macro to fill the pools dataset *****; |
| 246 | **********************************************************************; |
| 247 | %WINNER(amount=7); |
| 248 | %WINNER(amount=0); |
| 249 | %WINNER(amount=0); |
| 250 | %WINNER(amount=10000); |
| 251 | %WINNER(amount=0); |
| 252 | |
| 253 | %WINNER(amount=0); |
| 254 | %WINNER(amount=0); |
| 255 | %WINNER(amount=0); |
| 256 | %WINNER(amount=0); |
| 257 | %WINNER(amount=0); |
| 258 | |
| 259 | %WINNER(amount=4); |
| 260 | %WINNER(amount=4); |
| 261 | %WINNER(amount=100); |
| 262 | %WINNER(amount=0); |
| 263 | %WINNER(amount=0); |
| 264 | |
| 265 | %WINNER(amount=1000000); |
| 266 | %WINNER(amount=4); |
| 267 | %WINNER(amount=7); |
| 268 | %WINNER(amount=0); |
| 269 | %WINNER(amount=0); |
| 270 | %WINNER(amount=0); |

Below is a detailed summary of the specifications for the program.

### Line 5.

Start of Section I that sets up a dataset of all possible pools. For illustrative purposes, the program generates three pools of each of the available sizes. The available pool sizes are determined beforehand, so that all possible winnings can be equally divided between the players/tickets in the pool. In this case, the possible pool sizes are 2 lottery tickets per pool, 4 lottery tickets per pool, 5 lottery tickets per pool, 10 lottery tickets per pool, 20 lottery tickets per pool, 25 lottery tickets per pool or 50 lottery tickets per pool. The dataset ‘POOLS’ accomplishes that so that each record in the dataset is one possible pool, with a unique POOL_ID.

### Line 19.

Dataset ‘POOLS2’ transposes the dataset ‘POOLS’ so that each record in the dataset will hold a lottery ticket in the pool. Since this data step is only used to set up the underlying structure, the dataset ‘POOLS2’ will not actually hold any lottery ticket information, but instead provides default null values for all the required variables (details are provided below in the appropriate section).

### Line 29.

In addition, dataset ‘POOLS2’ assigns a unique POOL_REC value for each record within a unique POOL_ID, with a starting value of 1 and an ending value of 50 (the largest pool size).

### Line 51.

Dataset ‘POOLS_FINAL’ keeps only the records where POOL_REC≦POOL_ID, allowing for the POOL_REC to increment by 1 with a starting value of 1 and an ending value equal to the POOL_ID.

### Line 58.

Start of Section II that provides the local (in-program) macro to demonstrate the process of ‘playing the lottery’. The macro has only one input parameter: pool size.

### Line 64.

Choosing all available pools that have not been fully occupied yet. Dataset ‘_{—}5POOL’ keeps the records from the ‘POOLS_FINAL’ dataset that belong to the chosen pool size that have not been fully claimed (that is, at least one open slot exists in the pool). Assign an ID variable that equals the record in the dataset, with a starting value of 1 and an ending value equal to the number of available pools.

### Line 72.

Create a macro variable &NOBS that holds the number of available pools.

### Line 78.

Randomize all the available pools. That is, randomize the order of ID variable.

### Line 84.

Choose the first available pool, based on the randomized ID variable. Assign a unique TICKET_ID to the record, using a random number generator. Here, for illustrative purposes, a uniform distribution is called to generate a random number between 1 and 99999999. The method of providing a TICKET_ID is not relevant, as long as each lottery ticket (i.e., number combination played by a single player/ticket) can be uniquely accounted for.

### Line 93.

Create a macro variable &POOLID that holds the value of the chosen POOL_ID. Create a macro variable &TICKID that holds the value of the chosen TICKET_ID.

### Line 101.

Insert the TICKET_ID into the first empty (available) row in the POOLS_FINAL dataset that corresponds to the chosen POOL_ID, indicating that a lottery ticket (i.e., TICKET_ID) has been assigned to the chosen pool.

### Line 113.

Create a macro variable &POOLREC that holds the value of the chosen POOL_REC.

### Line 119.

Finalize the ‘POOLS_FINAL’ dataset by updating the value of TICKET_ID that corresponds to the chosen POOL_ID and POOL_REC, and assigning a value of 1 to CLAIMED variable, indicating that this record in the pool is no longer empty (available).

### Line 135.

Start of Section III that provides the local (in-program) macro that can be called to fill in the ‘POOLS_FINAL’ dataset. Each % PLAY_LOTTERY line (program lines 140, 143, 146, 149, 152, 155 and 158) can be submitted individually for illustrative purposes, or the entire macro can be called at once (program line 163).

### Line 167.

Start of Section IV that provides the local (in-program) macro to choose a winning ticket and update the ‘POOLS_FINAL’ dataset with the payout amount per ticket and the payout amount per player. In reality, the winning tickets are not chosen at random, but are based on lottery drawings. The macro has only one input parameter: winning amount.

### Line 173.

Choosing all eligible, available tickets (i.e., records) that are not associated with a winning amount yet. Dataset ‘POOLS_FINAL2’ keeps the records from the ‘POOLS_FINAL’ dataset that have no winnings associated with it. Assign an ID variable that equals the record in the dataset, with a starting value of 1 and an ending value equal to the number of available pools.

### Line 179.

Create a macro variable &NOBS that holds the number of available tickets.

### Line 185.

Randomize all the available tickets. That is, randomize the order of ID variable.

### Line 191.

Choose the first available ticket, based on the randomized ID variable. The value of PAYOUT_TICKET variable will be set to equal the winning amount for the ticket, and the PAYOUT_PERSON variable will be set to equal the winning ticket amount divided by the pool size. In that way, each player in the pool will receive an equal fraction of the winning, based on the winning amount and the pool size.

### Line 200.

Create a macro variable &PAYTIC that holds the value of the PAYOUT_TICKET. Create a macro variable &PAYPLAY that holds the value of the PAYOUT_PERSON. Create a macro variable &POOLID that holds the value of the chosen POOL JD. Create a macro variable &TICKETID that holds the value of the chosen TICKET_ID.

### Line 208.

Modify the ‘POOLS_FINAL’ dataset by updating the value of PAYOUT_PERSON for every ticket that is in the same pool as the winning ticket. Modify the ‘POOLS_FINAL’ dataset by updating the value of PAYOUT_TICKET that corresponds to the chosen TICKET_ID, and assigning a value of 1 to WINNER variable, indicating that this ticket has been processed in determining the winning amount, and will no longer be chosen as a possible winner.

### Line 223.

Finalize the ‘POOLS_FINAL’ dataset by summing the payout amounts per player (i.e., ticket in any given pool) in case multiple tickets in the pool have produced a winner. In that case, the total winnings are equally distributed among all the players in the pool. The variable PAYOUT_PERSON_FINAL keeps this information. Similarly, the variable PAYOUT_TICKET_FINAL holds the winning amount associated with the specific record (TICKET_ID).

### Line 232.

The values of PAYOUT_TICKET and PAYOUT_PERSON are set to their default null values in the ‘POOLS_FINAL’ dataset so that another winning amount can be processed.

### Line 244.

Start of Section V that calls the macro % WINNER as many times as there are winning tickets. Since $0 is considered a winning amount, the macro can be called as many times as there are records in the ‘POOLS_FINAL’ dataset. For illustrative purposes, twenty macro calls are provided here.

What is claimed is:

1. A non-scratch lottery gaming system pooling method that allows lottery players to pool their tickets, and distribute the winning amount from all tickets in the pool equally between the players in that pool, increasing the odds of a lottery player receiving a payout, since the player would receive a payout if any of the tickets in the player's pool were a winner, not just the single ticket that the player purchased.

2. This invention can be applied to any US national and international non-instant (e.g., scratch tickets) lottery where a certain set of numbers (or picks) is selected from a certain group of numbers, and is not limited to those lotteries mentioned in this application (Powerball and Mega Millions).

3. A non-scratch lottery gaming system pooling method according to claim 1, wherein each purchased and pooled lottery ticket is placed in a pool, chosen either randomly by the computer software or the player, comprising of a pre-determined number of players/tickets referred to as ‘pools’ (e.g., pool sizes of 2, 4, 5, 10, 20, 25, 50 or 100 tickets are possible for Powerball; pool sizes of 2, 4, 5, 10, 20, 25 or 50 are possible for Mega Millions).

4. A non-scratch lottery gaming system pooling method according to claim 1, further comprising: the computer software randomly choosing a pool from all the available pools of a given size, based on unique pool ID.

5. A non-scratch lottery gaming system pooling method according to claim 1, further comprising: the computer software determining whether each ticket is a winning ticket, that is, what is the payout associated with the ticket). More than one ticket in a pool can be a winner.

6. A non-scratch lottery gaming system pooling method according to claim 1, further comprising: the computer software determining the amount paid out to each player in each of the pools. This is equal to the total pool winnings divided by the pool size (i.e., number of players/tickets in the pool).
